(19) United States
(12) Patent Application Publication
(10) Pub. No.: US 2013/0258105 A1
(43) Pub. Date: Oct. 3, 2013

(54) DYNAMIC FIELD MONITORING SYSTEM IN INTENSITY MODULATED RADIOTHERAPY BEAMS

(71) Applicant: NEW YORK UNIVERSITY, New York, NY (US)

(72) Inventor: Gabor Jozsef, Hartsdale, NY (US)

(73) Assignee: New York University, New York, NY (US)

(21) Appl. No.: 13/853,497

(22) Filed: Mar. 29, 2013

Related U.S. Application Data
(60) Provisional application No. 61/618,442, filed on Mar. 30, 2012.

(51) Int. Cl. G01J 1/42

(52) U.S. Cl. CPC G01J 1/4257
USPC 348/143

(57) ABSTRACT

Systems and method for monitoring an actual shape of a radiation therapy beam. The radiation therapy beam passes through a scintillation sheet. A light field emitted by the scintillation sheet is captured by a camera. Image data captured by the camera is processed to generate a processed image of the actual shape of the radiation therapy beam. The processed image of the actual shape of the radiation therapy beam may be compared to a programmed shape of the radiation therapy beam.

### CROSS REFERENCE TO RELATED PATENT APPLICATIONS

The present application claims the benefit of priority to U.S. Provisional Patent Application 61/618,442 filed Mar. 30, 2012, the contents of which are incorporated by reference herein in its entirety.

### BACKGROUND

The present application relates generally to a field monitoring system for radiotherapy. Modulated radiotherapy, such as dynamic wedge or intensity modulated radio therapy (IMRT) utilizes a computer-controlled treatment system to deliver varying dose distributions to a particular area within a patient. A problem encountered by modulated radiotherapy treatment systems is that the systems are dependent on the software of the treatment machine monitoring its own mechanics. In other words, the treatment machine monitors itself. Presently, there is no easy to use in-vivo dynamic field monitoring system of a radiation beam involved in modulated radiotherapy procedures.

A need exists for improved technology, including technology that may address the above described disadvantage.

### SUMMARY

One embodiment relates to a method for monitoring an actual shape of a radiation beam during a modulated radiotherapy session. The method comprises applying, by a treatment machine, the radiation beam to a scintillation sheet. An image of a scintillating light field on the scintillation sheet is captured by a camera. The image is transmitted to a processing circuit. Image processing is performed by the processing circuit on the image. A processed image of the actual shape of the radiation beam is generated.

One embodiment relates to a dynamic field monitoring device for monitoring a shape of a radiation beam during a modulated radiotherapy session. A scintillation sheet is positioned in a path of the radiation beam. A camera is positioned to receive light emitted by the scintillation sheet. A processor is configured to receive image data from the camera, process the image data, and generate an image of the shape of the radiation beam corresponding to the received image data. A user interface is configured to display a comparison of the actual shape and a programmed shape of the radiation beam. The dynamic field monitoring device is connectable to a treatment machine configured to controllably emit the radiation beam having a selected shape. The processor is in communication with the camera and the treatment machine.

One embodiment relates to a non-transitory computer-readable medium having instructions thereon that cause one or more processors to perform operations. The operations of the one or more processors comprising: receiving an image of a scintillating light field on a scintillation sheet; performing image processing on the image; and generating a processed image of an actual shape of a radiation beam.

One embodiment of the invention relates to a dynamic field monitoring system configured to monitor a radiation beam involved in modulated radiotherapy procedures directly and independently of a control mechanism of a treatment machine. The dynamic field monitoring system comprises a scintillating sheet, a digital video camera or webcam and a processing circuit programmed for image segmentation. The components of the dynamic field monitoring system allow the dynamic field monitoring system to monitor the shape of the radiation beam in real time, while a patient undergoes treatment.

Additional features, advantages, and embodiments of the present disclosure may be set forth from consideration of the following detailed description, drawings, and claims. Moreover, it is to be understood that both the foregoing summary of the present disclosure and the following detailed description are exemplary and intended to provide further explanation without further limiting the scope of the present disclosure claimed.

### BRIEF DESCRIPTION OF THE DRAWINGS

The disclosure will become more fully understood from the following detailed description, taken in conjunction with the accompanying figures, in which:

FIG. 1 is an exemplary embodiment of a dynamic field monitoring system.

FIG. 2 is another exemplary embodiment of a dynamic field monitoring system.

FIG. 3 is a planar view of a beam image on a scintillation sheet of the dynamic field monitoring system of FIG. 2.

FIG. 4 is an exemplary method for processing an image obtained by the dynamic field monitoring system of FIG. 1.

FIG. 5A is an image from the perspective of a camera of the dynamic field monitoring system of FIG. 1 before correcting image shape.

FIG. 5B is the image of FIG. 5A after correcting image shape.

FIG. 6A is the image of FIG. 5B before correcting image intensity.

FIG. 6B is the processed image of FIG. 6A after performing image segmentation.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

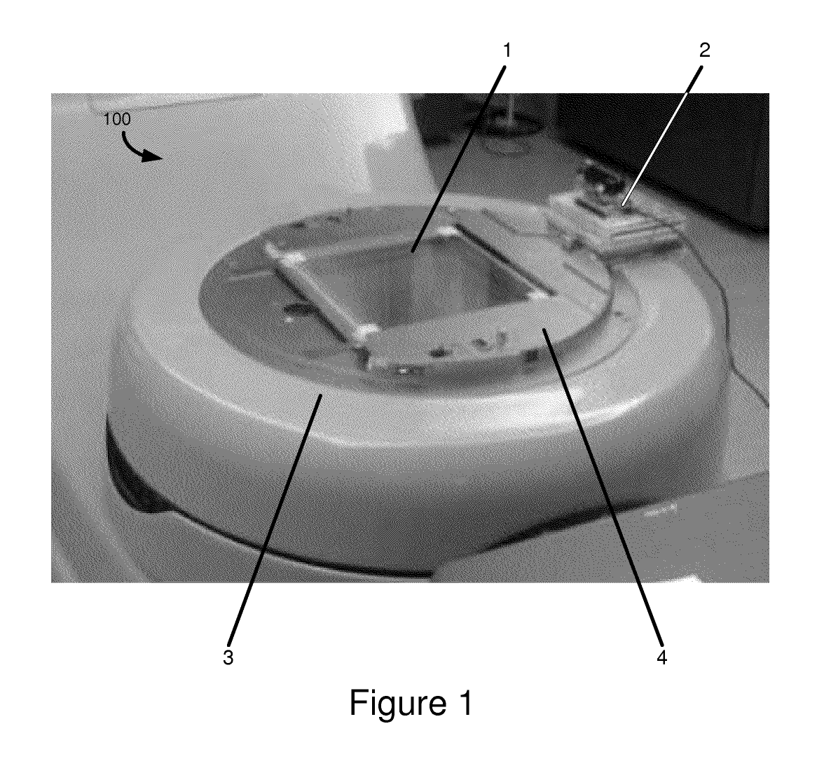

Referring now to FIG. 1, in a first embodiment, a dynamic field monitoring system 100 includes a scintillation sheet 1, a camera 2 and a treatment machine 3. The treatment machine 3 includes an accessory holder 4.

The scintillation sheet 1 is a conventional scintillation sheet, as is known in the industry. For example, the scintillation sheet 1 may be a REXON RP-408 plastic scintillator. The scintillation sheet 1 may be any thickness, preferably a thickness less than 0.5 cm. The scintillation sheet 1 may be plastic. The scintillation sheet 1 may be any size or shape, provided that an area of the scintillation sheet 1 is larger than a field area of a radiation beam of the treatment machine 3. In one embodiment, the radiation beam may be shaped through the use of a multi-leaf collimator.

The camera 2 may be any digital camera or web camera. In one embodiment, the camera 2 is a web camera connected via universal serial bus (“USB”) to a processing circuit. The camera 2 may be low resolution, for example, 640×480 resolution.

In one implementation, selection of the scintillation sheet 1 and the camera 2 may be co-dependent. A scintillating light field 6 of the scintillation sheet 1 must match the emitted light spectrum and spectral sensitivity of the camera 2. The scintillation sheet 1 should be thin to diminish an amount of scattered light reaching the camera 2. The scattered light is caused by internal light scattering and scintillation from scattered radiation in the scintillation sheet 1. Because scintillation sheet 1 is thin, higher scintillation yield may be necessary. Thus, the camera 2 should be shielded from ambient light or should have filters to eliminate it. Further, in one embodiment, it should be appreciated that the desired sensitivity of the camera to the wavelengths of light emitted by the scintillation sheet 1 is greater the thinner the sheet and/or the lower the scintillation yield.

The treatment machine 3 is a conventional treatment machine, as is known in the industry. In one embodiment, the treatment machine 3 is capable of emitting a beam of radiation whose intensity and shape is controlled. Typically, treatment will involve applying predetermined fixed or time-varying beam shapes in order to maximize radiation to the target tissue and to minimize the radiation to surrounding tissue.

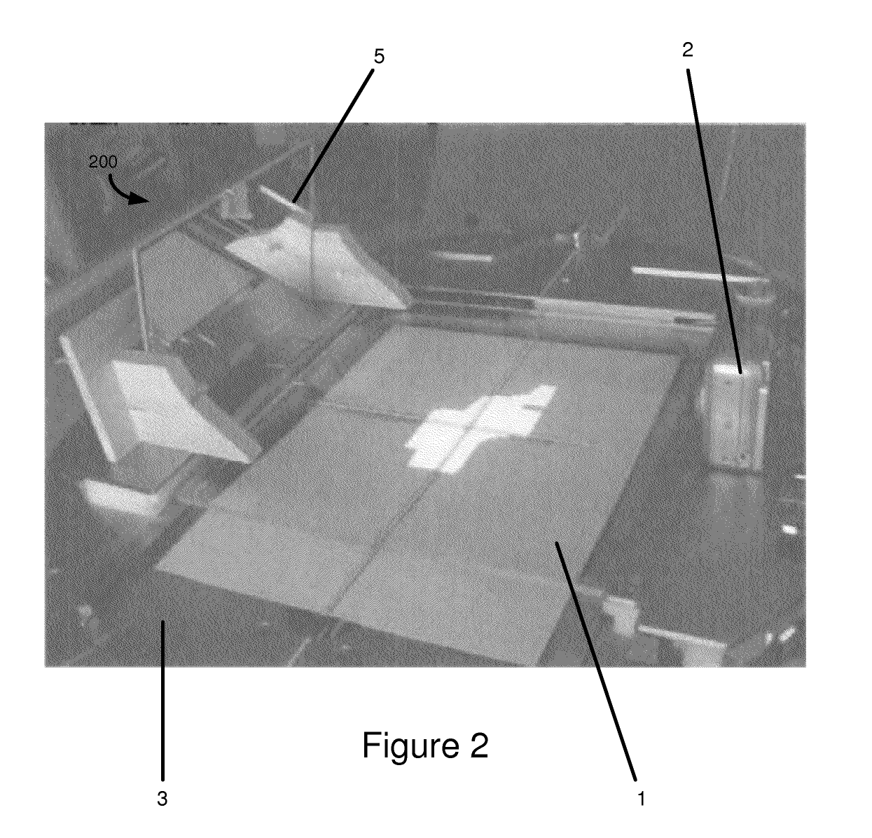

Referring now to FIG. 2, in a second embodiment, a dynamic field monitoring system 200 includes a scintillation sheet 1, a camera 2, a treatment machine 3 and a mirror 5. The treatment machine 3 includes an accessory holder 4. Scintillation sheet 1, camera 2, treatment machine 3 and accessory holder 4 are identical to those of the dynamic field monitoring system 100, so they have been provided with the same reference numbers.

The mirror 5 can be any shape or size, provided that the mirror 5 is large enough to reflect the entire scintillating light field 6 that appears on the scintillation sheet 1 when a radiation beam of the treatment machine 3 is activated. The mirror 5 is preferably attached onto a frame of the treatment machine 3 outside of the field area of the radiation beam of the treatment machine 3.

Referring now to FIGS. 1-2, the scintillation sheet 1 is inserted in the top of the accessory holder 4 of the treatment machine 3. The camera 2 is placed on a side of the accessory holder 4, outside of the field area of the radiation beam of the treatment machine 3. In the first embodiment, the camera 2 is positioned to face the scintillation sheet 1 (see FIG. 1) such that the scintillation sheet 1 is within the field of view. In one embodiment, the scintillation sheet 1 is located at the focus of the camera 2. The camera 2 may be positioned at an angle with respect to the scintillation sheet 1 such that the camera lens is neither parallel with nor perpendicular to the scintillation sheet 1. In the second embodiment, the mirror 5 is positioned on a side of the accessory holder 4 directly across from the camera 2. The camera 2 is positioned with the mirror 5 in the field of view of the camera 2. In one embodiment, the mirror 5 is positioned at the focus of the camera 2. In one embodiment, the camera 2 faces straight ahead at the mirror 5 (see FIG. 2). The mirror 5 may be positioned non parallel and non perpendicular with respect to the camera 2 and/or the scintillation sheet 1. In both embodiments, the camera 2 is preferably positioned such that a center of the camera's field of view coincides with a center of the field area of the radiation beam. The dynamic field monitoring system 100, 200 can be attached to the treatment machine 3 permanently or temporarily during each radiotherapy session.

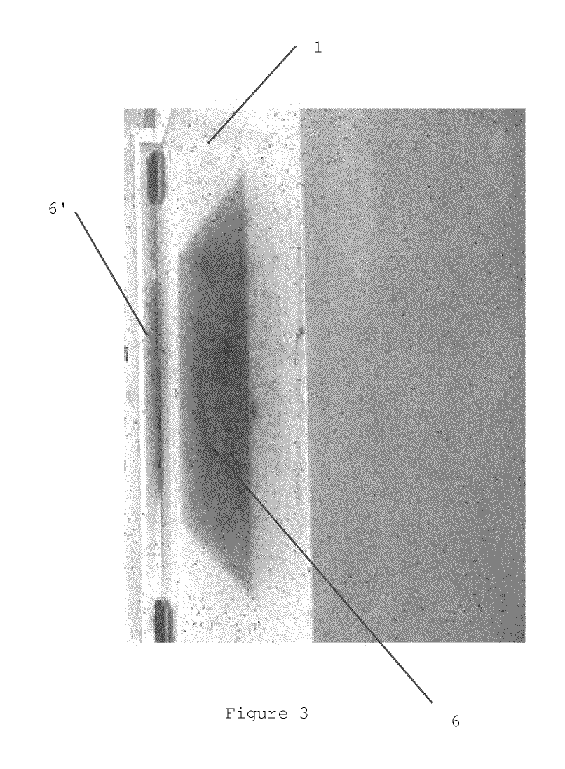

Referring now to FIG. 3, when the radiation beam is activated, the shape of the scintillating light field 6 on the scintillation sheet 1 at any moment of the modulated radiotherapy procedure corresponds to a shape of the radiation beam striking the scintillation sheet 1. The light field 6 generated upon interaction of the radiation beam with the scintillation sheet 1 is sufficiently strong to observe with the camera 2. As noted above, the camera 2 may directly capture the shape of the scintillating light field 6. If a mirror 5 is present, the camera 2 will capture a shape of a reflected scintillating light field 6′, as reflected off of the mirror 5. In one embodiment, multiple cameras may be utilized to capture both a reflected light field 6′ and a direct light field 6. In a further embodiment, a single camera may capture both the reflected light field 6′ and the direct light field 6.

In one embodiment, the image processing requires multiple processing steps. Because, in certain embodiments, the camera is seeing the beam from an oblique angle, it is necessary to correct for the geometrical distortion. Further, differences in path length from the proximal and distal edges of the scintillation sheet cause inhomogeneity of the light intensity. This is correctable by creating a dosimetric calibration: irradiating the whole scintillation sheet with a homogeneous dose and creating a pixel by pixel intensity correction matrix. In addition, image segmentation is required in certain embodiments to quickly identify the rapidly changing shape of the light field which, at each time point, corresponds to the shape of the radiation beam. Image segmentation algorithms such as, but not limited to, threshold based or contour tracking may be used.

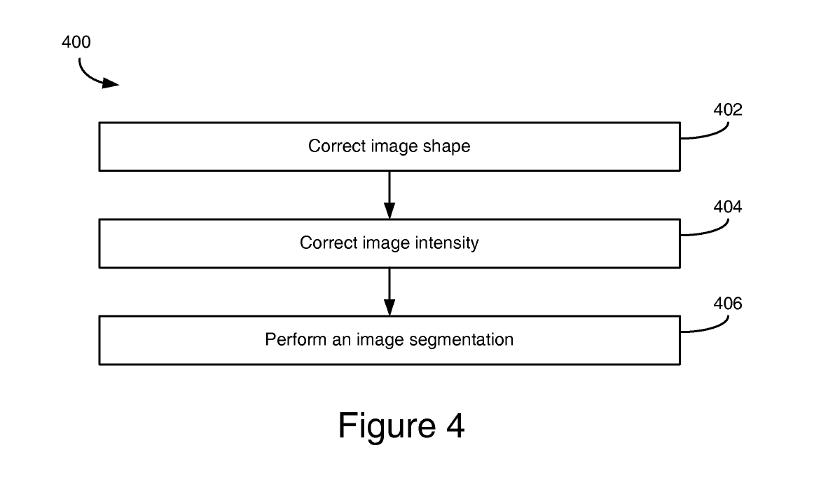

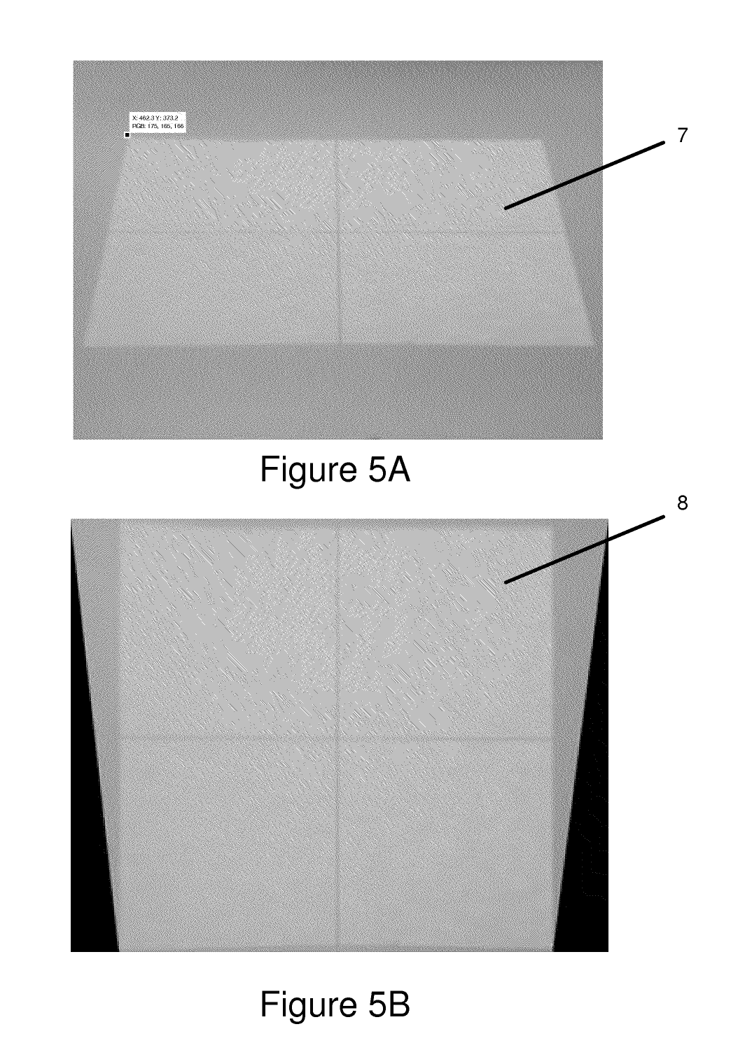

Referring now to FIG. 4, a method of image processing 400 is described. Referring now to FIGS. 5A-5B, a step of shape correction is described (step 402). As illustrated in FIG. 5A, the camera 2 transmits an image 7 of the light field 6. For example, if the light field 6 is a square on the scintillation sheet 1, the transmitted image 7 will appear to be a rhomboid due to the angle of the camera with respect to the scintillation sheet 1. Therefore, it is necessary to process the transmitted image 7 in order to obtain a “beam's eye view” of the shape of the radiation beam. To process the image 7, a processing circuit is configured to take the image 7 and determine the pixel coordinates of contours of the image 7. Using geometry, the processing circuit utilizes a transformation matrix to convert the image 7 into a beam's eye view image 8. Referring now to FIG. 5B, image 7, which appeared to be a trapezoid in FIG. 4A, is converted back into a square in the beam's eye view image 8.

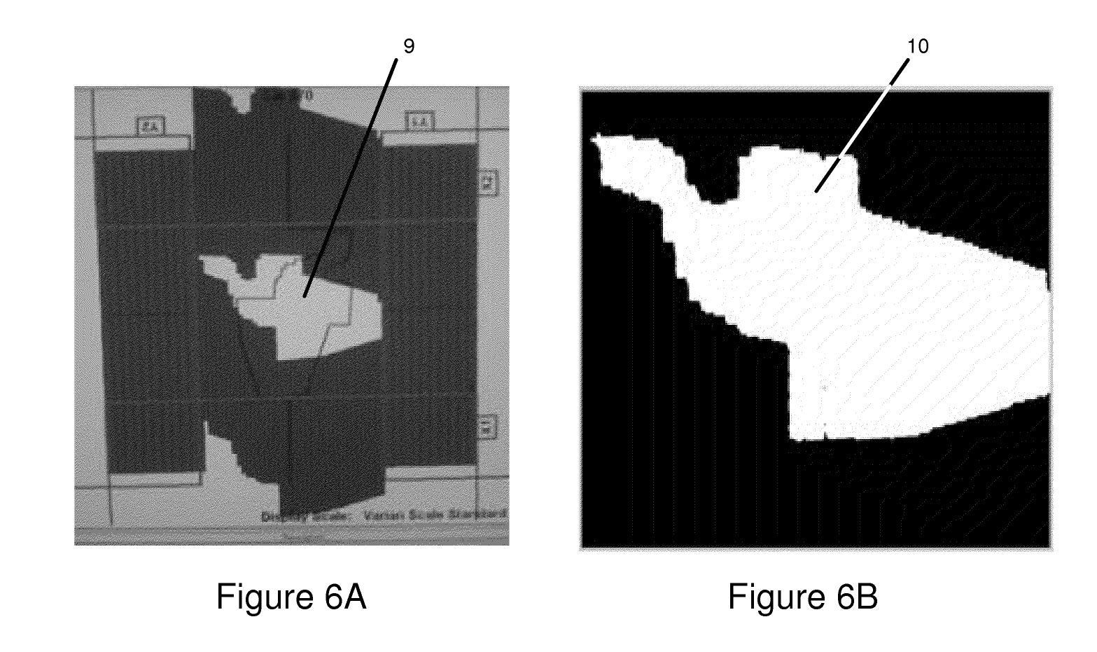

Referring now to FIG. 6A, a step of image intensity correction is described (step 404). Due to varying distances from points in the light field 6 to the camera 2 and possibly varying light yields at different points on the scintillation sheet 1, it is necessary to apply an image intensity correction. The image 8 can be normalized to an arbitrary point and correction values for every pixel can be obtained to equalize intensity within the field. This step yields a corrected image 9.

Referring now to FIG. 6B, a step of image segmentation is described (step 406). In one embodiment, in order to reconstruct the shape of the radiation beam from the corrected image 9, threshold based image segmentation is utilized. For example, a processing circuit may normalize the image 9 to a center point and discard any pixel having less than a threshold fraction of the center point's intensity. The threshold fraction is an arbitrary value, for example, one-half. In other embodiments, other known segmentation methods may be utilized. The processed image 10 provides a reconstructed view of the beam as seen from the patient.

Image processing 400 allows for continuous, real time monitoring of the radiation beam shape. In one embodiment, in order to follow fast moving multi-leaf collimators in a modulated radiotherapy beam, image processing 400 should be completed in approximately 0.1 seconds or less, corresponding to less than 2 mm of leaf motion). Actual image reconstruction of 0.9 sec has been achieved. A time of less than 0.1 second corresponds to a positional discrepancy of less than 2.5 mm between the actual and reconstructed position of the moving field shaping leafs.

Utilizing the processed image 10 resulting from executing image processing 400, an operator of the treatment machine 3 may dynamically monitor the shape of the radiation beam used in an intensity modulated radiotherapy procedure. Specifically, the dynamic field monitoring system 100, 200 are employed for in vivo beam monitoring just before the radiation beam enters the patient. The operation of the dynamic field monitoring system 100, 200 and subsequent image processing 400 is automatic and practically real-time. It should be appreciated there may be some slight delay in certain implementations for the display of the processed image.

In one embodiment, a display unit is configured to display the processed image 10 and a predicted shape of the radiation beam, as provided by software of the treatment machine 3. In one embodiment, the processed image 10 will be overlaid on the predicted shape. In another embodiment, the processed image 10 will be displayed next to the predicted shape. Discrepancies between the processed image 10 and the predicted shape indicate errors. Once an error is apparent, the treatment machine 3 may be configured to automatically interrupt the beam if the discrepancy exceeds a threshold value. Alternatively, the operator may manually interrupt the beam after noting a discrepancy. Thus, the dynamic field monitoring system 100, 200 allows the operator to monitor the radiation beam directly and independently of the control mechanism of the treatment machine 3. This provides increased treatment safety and a measure of quality assurance. In order to detect discrepancies between them, the start of the planned display needs to be synchronized with the start of the beam. Also, error detection may consider whether a determined discrepancy in the field shapes constitutes an error. In one implementation, individual blocking leaf positions are derived and compared. In another implementation, more complex shape analyses are utilized to identify error.

In one embodiment, a plurality of processed images 10 captured during the treatment may be saved by the processing circuit and summed up. An intensity of each pixel of the summed up images is proportional to the radiation dose delivered to the patient through that pixel. This information can be used to reconstruct and calculate a dose distribution actually delivered to the patient. The delivered dose distribution can be compared to a planned dose distribution. The calculation of the delivered dose distribution must take into account the absorption of radiation through the scintillation sheet 1. In one embodiment, the absorption by the scintillation sheet 1 is approximately 3%.

Dynamically acquired images can be integrated across time to give a complete picture of the delivered fluences. The processed images and/or the dosage information maybe utilized in combination with tomographic imaging tracking inter-fractional changes in anatomy. The combination of the anatomic images and the collected fluence can be used to investigate the dosimetric effect of inter-fraction setup errors.

The construction and arrangements of the dynamic field monitoring system, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, image processing and segmentation algorithms, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

Embodiments of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus or processing circuit on data stored on one or more computer-readable storage devices or received from other sources.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors or processing circuits executing one or more computer programs to perform actions by operating on input data and generating output. The processes and logic flows can also be performed by, and apparatus can also be implemented as, special purpose logic circuitry, e.g., an FPGA or an ASIC.

Processors or processing circuits suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display), OLED (organic light emitting diode), TFT (thin-film transistor), plasma, other flexible configuration, or any other monitor for displaying information to the user and a keyboard, a pointing device, e.g., a mouse trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method for monitoring an actual shape of a radiation beam during a modulated radiotherapy session, the method comprising:
applying, by a treatment machine, the radiation beam to a scintillation sheet;
capturing, by a camera, an image of a scintillating light field on the scintillation sheet;
transmitting the image to a processing circuit;
performing, by the processing circuit, image processing on the image; and
generating a processed image of the actual shape of the radiation beam.

2. The method of claim 1 wherein the image processing comprises:
correcting, by the processing circuit, a shape of the image transmitted by the camera;
correcting, by the processing circuit, an intensity of the image transmitted by the camera; and
performing, by the processing circuit, an image segmentation of the image transmitted by the camera.

3. The method of claim 1 further comprising generating display data configured to display the processed image on a user interface.

4. The method of claim 3, wherein displaying processed image on the user interface is done in substantially real time providing a continuous image of the radiation beam shape.

5. The method of claim 3 further comprising generating display data configured to display a programmed shape of the radiation beam on the user interface.

6. The method of claim 5 further comprising:
comparing the processed image of the actual shape and the programmed shape of the radiation beam;
calculating a discrepancy between the processed image of the actual shape and the programmed shape of the radiation beam; and
interrupting the radiation beam if the discrepancy exceeds a threshold value.

7. The method of claim 1, further comprising determining a radiation dosage delivered by summing the intensity of each pixel in a plurality of processed images.

8. The method of claim 1, further comprising shielding at least a portion of ambient light from the camera.

9. A dynamic field monitoring device for monitoring a shape of a radiation beam during a modulated radiotherapy session, the dynamic field monitoring device comprising:
a scintillation sheet positioned in a path of the radiation beam;
a camera positioned to receive light emitted by the scintillation sheet;
a processor configured to receive image data from the camera, process the image data, and generate an image of the shape of the radiation beam corresponding to the received image data; and
a user interface configured to display a comparison of the actual shape and a programmed shape of the radiation beam,
wherein the dynamic field monitoring device is connectable to a treatment machine configured to controllably emit the radiation beam having a selected shape,
wherein the processor is in communication with the camera and the treatment machine.

10. The dynamic field monitoring device of claim 9, further comprising a mirror positioned to receive light emitted by the scintillation sheet, the camera positioned to receive light emitted by the scintillation sheet and reflected by the mirror.

11. The dynamic field monitoring device of claim 10, wherein the mirror is large enough and positioned to reflect an entirety of a scintillation light field of the scintillation sheet.

12. The dynamic field monitoring device of claim 10, wherein the mirror is positioned at a non-parallel, non-perpendicular first angle with respect to the camera lens and is positioned at a non-parallel, non-perpendicular second angle with respect to the scintillation sheet.

13. The dynamic field monitoring device of claim 9, wherein the scintillation sheet is positioned at the focus of the camera and the camera lens is at a non-perpendicular, non-parallel angle with respect to the scintillation sheet.

14. The dynamic field monitoring device of claim 9, wherein the treatment machine is configured for use in intensity modulated radiation therapy or dynamic wedge radiotherapy.

15. The dynamic field monitoring device of claim 9, wherein the camera is shielded or filter from ambient light.

16. The dynamic field monitoring device of claim 9, wherein a center of the camera's field of view coincides with a center of the field area of the radiation beam.

17. The dynamic field monitoring device of claim 9, wherein the scintillation sheet and camera are co-dependent such that the scintillation sheet's respective emitted light spectrum matches the camera's spectral sensitivity.

18. A non-transitory computer-readable medium having instructions thereon that cause one or more processors to perform operations, the operations comprising:
receiving an image of a scintillating light field on a scintillation sheet;
performing image processing on the image; and
generating a processed image of an actual shape of a radiation beam.

19. The non-transitory computer-readable medium of claim 18, wherein performing image processing comprises:
correcting a shape of the image;
correcting an intensity of the image; and
performing an image segmentation of the image.

20. The non-transitory computer readable medium of claim 15, wherein the operations further comprise:
comparing the processed image of the actual shape and a programmed shape of the radiation beam;
calculating a discrepancy between the processed image of the actual shape and the programmed shape; and
interrupting the radiation beam if the discrepancy exceeds a threshold value.
